(19) United States
(12) Patent Application Publication
(10) Pub. No.: US 2017/0001307 A1
(43) Pub. Date: Jan. 5, 2017

(54) METHOD FOR CONTROLLING AN AUTOMATED WORK CELL

(71) Applicant: STAUBLI FAVERGES, Faverges (FR)

(72) Inventor: Jean-Michel BONNET DES TUVES, Saint Ferreol (FR)

(21) Appl. No.: 15/191,747

(22) Filed: Jun. 24, 2016

(30) Foreign Application Priority Data
Jun. 30, 2015 (FR) 1556147

(51) Int. Cl. B25J 9/16; G05B 19/05

(52) U.S. Cl. CPC B25J 9/1602; G05B 19/056; G05B 2219/34287

(57) ABSTRACT

The invention relates to a method for controlling an automated work cell (2) including at least one robot arm (4) with at least three degrees of freedom (A1-A6), a programmable logic controller (6) suitable for developing a trajectory order (Om) based on an instruction to perform a trajectory of an application programmed in the programmable logic controller, a robot controller (10), suitable for steering the movement of the robot arm (4), and a communication bus (5) between the programmable logic controller (6) and the robot controller (10). The method comprises steps consisting of a) developing, in the programmable logic controller (6), a trajectory order (Om) including parameters for executing a trajectory defined at least between a departure point and an arrival point; b) transmitting the trajectory order (Om) developed in step a) to a computing unit (11) of the robot (10); c) developing, in the computing unit (11) of the robot controller (10) and based on the trajectory order (Om) transmitted in step b), elementary movement instructions for steering the robot arm (4) on the trajectory defined by the trajectory order (Om).

The invention relates to a method for controlling an automated work cell.

It is known from WO-A-2012/097834 to control a robot from a programmable logic controller (PLC) connected to the robot controller by a fieldbus. More particularly, it is known to use, at the PLC, programs for controlling a robot comprising functional blocks that correspond to movement segments of a trajectory of the robot. These blocks are interpreted by a robot controller interface that manages the movement commands able to be interpreted by the robot controller and transmits them via the bus. In the preferred embodiment, the movement commands form the movement queue of the robot controller.

This solution makes it possible to use the functionalities of the PLC to program the robot itself. Each functional block is programmable from a standard interface of the PLC by an operator, who does not need to master the programming language specific to the robot. The drawback of this system is that the PLC must have a robot controller interface specific to the robot.

JP-A-2011/062798 discloses a programming solution for the movements of the robot at the PLC in which memory addresses are each assigned to a robot command and the content of this memory defines a parameter of this command. For example, the address 10500 corresponds to a movement order. When the value stored at this address is 1, the nature of the movement command is a MOV. This solution is tedious to program due to the large number of commands to be transmitted.

The invention aims to resolve these drawbacks by proposing a method for controlling an automated work cell that is improved relative to the methods of the state of the art.

To that end, the invention relates to a method for controlling an automated work cell, including:
at least one robot arm with at least three degrees of freedom,
a programmable logic controller suitable for developing a trajectory order based on an instruction to perform a trajectory of an application programmed in the programmable logic controller,
a robot controller, suitable for steering the movement of the robot arm, and
a communication bus between the programmable logic controller and the robot controller.
   The method is wherein it comprises the following steps:
a) developing, in the programmable logic controller, a trajectory order including parameters for performing a trajectory defined at least between a starting point and an arrival point;
b) sending the trajectory order developed in step a) to a computing unit of the robot controller;
c) developing, in the computing unit of the robot controller and based on the trajectory order transmitted in step b), elementary movement instructions for steering the robot arm on the trajectory defined by the trajectory order.

Owing to the invention, the orders sent by the PLC are less numerous, which accelerates the execution of the trajectory. The programming of the PLC is simplified, since it does not require entering data specific to the robot arm and movements done by the robot arm during the execution of the application.

According to advantageous but optional aspects of the invention, such a method may incorporate one or more of the following features, considered in any technically allowable combination:
In the trajectory order developed in step a), the trajectory is defined by a reference to a set of predefined points stored in a memory of the robot controller, this reference being entered in a variable contained in the trajectory order.
In the trajectory order developed in step a), kinematic parameters to be used to execute the trajectory are defined.
The kinematic parameters to be used to execute the trajectory are defined by a reference to kinematic parameters stored in a memory of the robot controller and entered in a variable contained in the trajectory order.
In the trajectory order developed in step a), starting parameters for the first point of the trajectory and/or the approach to the last point of the trajectory, which are implemented by the robot controller in the execution of the trajectory, are defined.
The starting kinematic parameters for the first point of the trajectory and/or the approach to the last point of the trajectory are defined by a reference to starting and approach parameters stored in a memory of the robot controller and entered in variables contained in the trajectory order.
The trajectory order developed in step a) comprises actions to be performed by a tool equipping one end of the robot arm.
In the trajectory order developed in step a), the geometry of the tool to be used is defined.
The geometry of the tool to be used is defined by a reference to a predefined tool geometry stored in a memory of the robot controller, this reference being entered in a variable contained in the trajectory order.
The trajectory order developed in step a) comprises actions to be performed by a tool equipping one end of the robot arm, and the initiation of an action of the tool by the robot controller and conditions for initiation of this action are entered in a variable contained in the trajectory order.
The conditions for triggering the action of the tool consist of observing the state of advancement of a movement of the robot arm and triggering the action of the tool when the state of advancement of the movement reaches a predefined value.
In step a), the programmable logic controller updates inputs/outputs of this programmable logic controller based on execution parameters of the trajectory according to a defined exchange protocol, and in step b), the computing unit of the robot controller reads the inputs/outputs of the computing unit that correspond to the inputs/outputs of the programmable logic controller as part of this exchange protocol.

The invention will be better understood, and other advantages thereof will appear more clearly, in light of the following description of a control method according to its principle, provided as a non-limiting example in reference to the appended drawings, in which:

FIG. 1 is a diagram of an automated work cell implementing a method according to the invention;

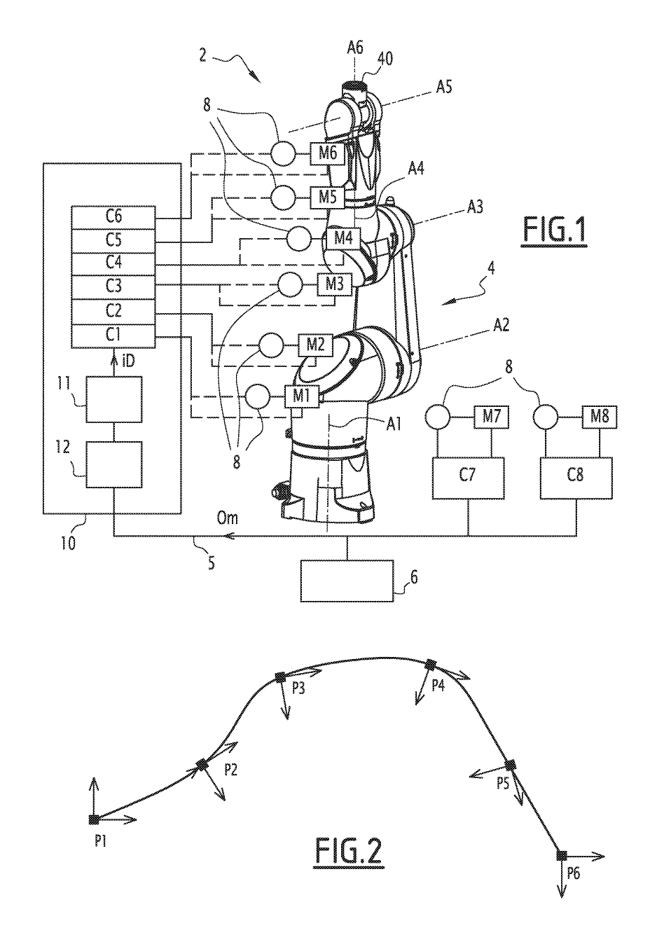

FIG. 2 is a movement trajectory done during an operating cycle of the method according to the invention;

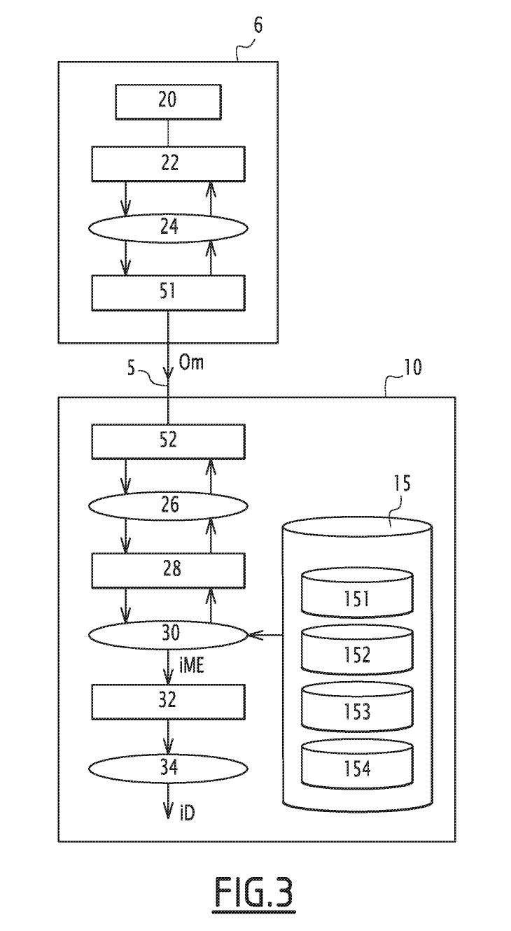

FIG. 3 is a block diagram of the operation of the method according to the invention;

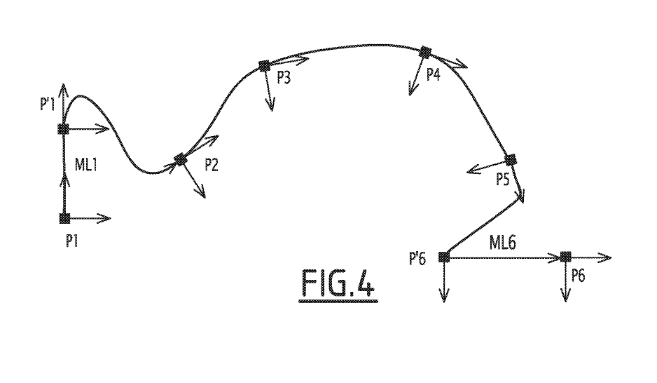

FIG. 4 is an alternative of the movement trajectory of FIG. 2.

The control method according to the invention applies to an automated work cell 2 shown in FIG. 1 and comprising at least one robot arm 4 with six degrees of freedom A1, A2, A3, A4, A5 and A6 corresponding to the articulation axes of the robot arm 4. The robot arm 4 also comprises motors M1 to M6 respectively making it possible to maneuver the parts of the robot arm 4 along the axes A1 to A6.

The robot arm 4 also comprises a tool 40 or “effector” situated at one end of the robot arm 4.

This automated work cell 2 also comprises a programmable logic controller 6 (hereinafter referred to as PLC) controlling the method and that contains a computing unit and memories, connected to the computing unit, in which sequences of actions required for the execution of the automated method are stored in the form of programs also called applications.

The automated work cell 2 comprises a robot controller 10 containing a computing unit 11 able to execute command programs of the robot arm 4. Preferably, the computing unit 11 is suitable for executing programs written in the VAL 3 language. Alternatively, the computing unit 11 may be suitable for executing programs written in other types of languages.

The computing unit 11 of the robot controller 10 generates movements from movement orders, i.e., computes articulation positions to be reached for each of the six axes A1 to A6, by applying the kinematic model associated with the robot arm 4, then computing positions to be reached for each motor M1 to M6, taking any reductions and couplings into account. The successive movement orders are stored in a movement pile. Alternatively, the computing unit 11 may not comprise movement piles and be suitable for knowing two movement orders, corresponding to the present movement that the computing unit 11 must implement, and the following movement.

The robot controller 10 comprises, for each motor M1 to M6, a respective motor controller C1 to C6 suitable for generating the supply currents in the corresponding phases of the motor M1 to M6 based on the angular position information coming to it from an encoder 8 equipping each motor M1 to M6 and that measures the angular position of that motor and sends it to the motor controller.

The PLC 6 and the robot controller 10 are connected by a fieldbus 5 that makes it possible to exchange Boolean and digital information available in the form of inputs/outputs. This information is encoded and decoded by respective drivers of the PLC 6 and the robot controller 10. At each moment, the inputs/outputs of the computing unit of the PLC 6 and the inputs/outputs of the robot controller 10 are identical.

The robot controller 10 is equipped with a communication board 12 by which the robot controller 10 connects both to the fieldbus 5 and an internal PCI bus, not shown, on which a board supporting the computing unit 11 is also connected.

The structure of the exchange zone of the fieldbus 5 is known by the computing unit of the PLC 6 and the robot controller 10, and the fieldbus 5 establishes an exchange protocol that in particular allows an application of the computing unit of the PLC 6 to send trajectory orders.

In the illustrated example, the work cell 2 comprises two motor controllers C7 and C8 suitable for controlling the motors M7 and M8 making it possible to maneuver part supply and removal devices of the automated method. These motors M7 and M8 are also equipped with encoders 8. The motor controllers C7 and C8 are connected to the PLC 6 and the robot controller 10 by the fieldbus 5.

According to the invention, upon each operation, the computing unit of the PLC 6 sends a trajectory order Om to the robot controller 10 via the fieldbus 5. The trajectory orders Om correspond to the performance of a movement that accumulates the elementary movements from one point to another. In other words, the trajectory orders Om designate trajectories grouping together a set of points. The articulation coordinates or Cartesian coordinates corresponding to the points are stored in a memory of the robot controller 10 that is accessible by the computing unit 11 of the robot controller 10. Owing to this new method, it is not necessary to transfer them to the PLC 6 to be able to execute the operating program of the cell 2.

The points of a trajectory can be stored in the memory of the robot controller 10 during a learning procedure. Using a learning controller, or “teach pendant”, not shown, connected to the robot controller 10, an operator manually moves the robot arm 4 over the definition points of the trajectory and stores those points in the memory of the robot controller 10.

The trajectory orders Om sent by the PLC 6 comprise variables that are entered during the development of the trajectory orders Om. The VAL 3 language has a notion of variable list. A list makes it possible to store an undetermined number of variables in a single element of the language. The variables can be stored according to a determined type that corresponds to a data structure. For example, a variable of the “POINT” type groups together six real numbers each corresponding to a degree of freedom. A variable of the “TOOLS” type groups together description parameters of the tool 40 such as the geometric transform that connects the base plane of reference to the plane of reference of the implementer, the number of the electric signal allowing its steering or its reaction time. A variable of the “MDESCS” type groups together kinematic parameters such as the speed, acceleration, or smoothing mode.

From these possibilities, the program of the work cell 2 creates, in a memory of the robot controller 10, a database 15 including the following elements:
a “POINTS” table 151 that contains N lists of variables of the “Point” type, N being the maximum number of referenced trajectories;
a “TOOLS” table 152 that contains M variables of the “Tools” type, M being the maximum number of referenced tool geometries;
a “MDESCS” table 153 that contains K variables of the “Mdesc” type, K being the maximum number of sets of referenced kinematic parameters.

These data are initialized by the installer based on the needs of his application. The “POINTS” table 151 is preferably programmed in the VAL 3 language in the form of a two-dimensional table of points. The first dimension is the identifier of a trajectory. The second dimension is the identification of one point on the trajectory. The points may be entered in Cartesian coordinates or articulation coordinates, i.e., attached to the axes A1 to A6. The “TOOLS” table 152 comprises the information relative to the tools used in the applications programmed in the PLC 6. The tables 151, 152 and 153 represent locations of the memory of the robot controller 10. Alternatively, each of the tables 151, 152 and 153 may be programmed in a dedicated memory zone.

To program the execution of a trajectory of the robot arm 4, the programmer of the PLC 6 uses a single movement instruction comprising the references to the variables of the database that define the desired trajectory. An instruction refers to a step of the program that is interpreted or compiled by a processor that will execute that instruction before going on to the next instruction. For example, in the ST (Structured Text) language, an instruction to initiate the execution of a trajectory may be expressed in the form of a MOVE instruction with four numerical parameters, written as follows:
MOVE (i,n,m,k)
   Where:—the variable i may assume the values 0, 1 and 2 and determines the type of trajectory to be used (0: articular, 1: Linear, 2: Circular);
the variable n (between 0 and N) references the trajectory points to be used;
the variable m (between 0 and M) references the geometry of the tool 40 to be used;
the variable k (between 0 and K) references the kinematic parameters to be used.

During the execution of the MOVE instruction, the computing unit of the PLC 6 copies the values of the four parameters of the MOVE instruction in the corresponding outputs as they are defined in the exchange protocol between the PLC 6 and the robot controller 10. After transmission by the fieldbus 5, the outputs are made available as inputs in the robot controller 10. These inputs are interpreted in the computing unit 11 by a server program preferably written in the VAL 3 language, which in turn develops corresponding elementary movement instructions iME for the end of the robot arm 4. The computing unit of the PLC 6 thus sends a trajectory order Om that corresponds to an execution instruction for a trajectory of the control program of the method. The computing unit 11 determines the elementary movements to be made to execute the trajectory specified in the trajectory order Om and compute corresponding movement instructions iD for each of the motors M1 to M6 of the robot arm 4.

For example, in the VAL 3 language, the elementary movement instructions iME of the end of the robot arm 4 are built in the following unique form:
MOVEX (Point, Tool, Mdesc)
   Where “X” corresponds to the movement type used and may assume the values J (articular movement), L (linear movement) or C (circular movement), “Point” is the destination of the movement, “Tool” describes the geometry of the tool 40 that is present on the robot arm 4, and “Mdesc” is a data structure that contains all of the kinematic parameters necessary to define a movement, including inter alia the speed, acceleration, deceleration, smoothing of the values.

In the case of a circular movement, an elementary movement instruction iME must specify at least two points.

For example, for each trajectory order Om corresponding to a linear trajectory of the robot arm 4 sent by the PLC 6, the computing unit 11 will determine, then execute a sequence of instructions, containing elementary movement instructions iME, which may be expressed as follows, in the VAL 3 language:

FOR index = 0 to NumberOfVariablesIn(POINTS[n])
MOVEL (POINTS[n] [index], TOOLS[m], MDESCS[o])
END_FOR

The sequences of elementary movement instructions iME corresponding to the articular or circular movement types are built similarly.

FIG. 3 illustrates the processing protocol for a trajectory order Om developed by the PLC 6. Based on an execution instruction for a trajectory of the control program of the method or application 20, the PLC 6 generates a trajectory order Om that consists of entering the inputs/outputs 22 with the references to the trajectory data to be used in the database 15. These references are:
the index of the desired trajectory in the bank of trajectory points 151,
the index of the movement descriptor to be used in the bank of movement descriptors 152,
the index of the tool to be used in the bank of tools 153.

The inputs/outputs 22 containing the trajectory order are sent to an input terminal 51 of the fieldbus 5 by a communication program 24 or driver.

Upon its arrival in the robot controller 10 via an output terminal 52 of the fieldbus 5, the trajectory order is converted by a communication program 26 or driver and sent into the computing unit 11 in input/output form 28.

The computing unit 11 includes a server program 30 written in VAL 3 that interprets the inputs/outputs 28 according to the defined protocol and generates the sequence of elementary movement instructions corresponding to the trajectory order Om by recovering the characteristics of the trajectory from the database 15. The elementary movement instructions iME come from the trajectory order Om stored in a pile of instructions 32, then are processed one after the next by a trajectory generator 34 that computes the movement instructions iD. The movement instructions iD for each of the motors M1 to M6 are computed by implementing a kinematic model of the transmissions of the robot arm 4, which defines any couplings or reducing ratios between the different parts of the robot arm 4. The movement instructions iD are sent to each of the motor controllers C1 to C6 that generate the control currents of the motors M1 to M6.

The invention in particular makes it possible to implement an application for picking up and moving objects, or “pick and place”, which consists of repeating a cycle in which a part is picked up at a point P1 and brought to a point P6 while passing through a series of points P2 to P5 to be placed there, the robot arm 4 next returning the point P1 to start the cycle again, as shown in FIG. 2.

This application is implemented by the PLC 6, the computing unit of which will execute a program that contains a series of movement operations of the robot arm 4 and actions by the tool 40. For a “pick and place” application, the tool 40 is generally a pneumatic suction cup.

To execute the pick and place application, the computing unit of the PLC 6 performs the following operations in a loop:

(beginning of the loop)

Initiate picking up of the part

Trigger the execution of the trajectory of the robot arm from P1 to P6

Initiate the release of the part

Trigger the execution of the trajectory of the robot arm from P6 to P1

(end of the loop)

According to one optional aspect of the invention shown in FIG. 4, in a “pick and place” application, it is advantageous to follow a determined movement to leave the first point P1 of the trajectory and a determined movement to come alongside the final point P6 of the trajectory. Generally, these movements are extraction movements of the part to be moved at the beginning of the trajectory and insertion of the part upon approaching the final point of the trajectory. These movements are done by a pure translation, for example for the insertion and/or extraction, optionally combined with a rotation if screwing or unscrewing is necessary.

The approach and departure movements are generally specific to the automated process: they depend on the manipulated parts and the supports receiving them. To achieve this specificity, additional parameters associated with a trajectory command are available to the programmer of the PLC 6. These additional parameters may be expressed as follows:
Tdepart corresponds to a reference on a geometric transform of the database of the robot controller 10. This geometric transform is to be applied to the first point P1 of the trajectory to define a departure point P′1.
mdescDepart corresponds to a reference on a movement descriptor of the database of the robot controller 10. It defines the kinematic parameters to be used for the departure trajectory extending between the points P1 and P′1.
Tappro corresponds to a reference on a geometric transform of the database of the robot controller 10. This geometric transform is to be applied to the last point P6 of the trajectory to define an approach point P′6.
mdescAppro corresponds to a reference on a movement descriptor of the database of the robot controller 10. It defines the kinematic parameters to be used for the approach trajectory extending between the points P′6 and P6.

The Tdepart and Tappro parameters refer to transforms entered in a table 154 of transforms of the database 15. The mdescDepart and mdescAppro parameters refer to types of movements entered in the “MDESC” table 153.

The instructions for the execution of a trajectory developed by the programmer of the PLC 6 and interpreted by the PLC 6 in trajectory orders Om to perform an operation comprising specific departure and approach movements may be written, for example in the ST language, as follows:
MOVE (i, n, m, o, Tdepart, mdescDepart, Tappro, mdescAppro)

These parameters are transmitted in the same way as the other parameters of the trajectory, by new outputs specified in the exchange protocol.

To execute the departure and approach movements, the server program 30 automatically computes the additional points P1′ to be inserted between the points P1 and P2 and P6′ between the points P5 and P6. These additional points are computed by applying the respective Tdepart and Tappro geometric transform to the first and last points P1 and P6 of the trajectory in question. For this type of trajectory order Om that includes specific approach and departure movements, the server program 30 adds a linear movement ML1 at the beginning of the trajectory toward the departure point P′1 computed with the kinematic parameters mdescDepart and a linear movement ML6 from the approach point P′6 computed at the end of the trajectory with the kinematic parameters mdescAppro. In the VAL 3 language, the sequences of instructions containing the elementary movement instructions iME generated by the computing unit 11 may be written as follows:

pointDepart= POINTS[n] [0]*depart
MOVEL (pointDepart ,TOOLS[m], mdescDepart )
FOR index= 1 to NumberOfVariablesIn(POINTS[n])−1
MOVEL (POINTS[n] [index], TOOLS[m], MDESCS[o])
END_FOR
pointAppro= POINTS[n] [NumberOfVariablesIn(POINTS[n])]*appro
MOVEL (pointAppro,TOOLS[m], MDESCS[o])
MOVEL (POINTS[n] [NumberOfVariablesIn(POINTS[n])], TOOLS[m],
mdescAppro)

According to one embodiment of the invention that is not shown, the method according to the invention may apply to movements only specific to the departure from the first point P1, or only to the approach toward the last point P6.

According to another optional aspect of the invention, in a “pick and place” application, it may be advantageous to anticipate the control of the tool 40 such that the cycle time is not penalized by the reaction time of the tool 40. This synchronization operation may be done effectively from the robot controller 10. The robot controllers generally have the possibility of triggering an action when the controlled robot arm reaches a given position.

To achieve this specificity, additional parameters associated with an instruction for executing a trajectory are available to the installer of the PLC 6. These additional parameters may be defined as follows, for example in the case of a “pick and place” application:
ActionTrigger corresponds to a percentage comprised between 0 and 100 of advancement of the trajectory that connects the approach point P′6 to the last point P6 of the trajectory. A value “0” or “100” respectively means that the action is triggered on the approach point P′6 or on the final point P6 of the trajectory.
OpenOrClose is a Boolean commands that specifies whether the expected action is to open or close the tool 40, in the event the latter is for example a gripper making it possible to grasp an item. Alternatively, this command may be adapted to activate or deactivate a particular functionality of the tool 40.

These parameters are entered in a MOVE instruction at the PLC 6, following other parameters defined beforehand, as follows:
MOVE (i, n, m, o, Tdepart, mdescDepart, Tappro, mdescAppro, ActionTrigger, OpenOrClose)

wherein ActionTrigger is a value, for example 50, if one wishes to execute the action at 50% of the advancement of the movement, and OpenOrClose is a Boolean value such as “TRUE” or “FALSE” depending on the desire to activate or deactivate the tool.

To achieve this functionality, the state of advancement of each commanded movement is observed. Indeed, any elementary movement command corresponding to an elementary movement instruction iME, for example of the “MOVE” type, refers to a movement identifier, for example in the “MotionID” variable. The robot controller 10 can be queried at any moment to determine the state of advancement of a particular movement. For example, in the VAL 3 language, the “GetMotionProgress(MotionID)” function, in which “MotionID” corresponds to the identifier of a precise movement, makes it possible to determine the state of advancement of that movement, in particular in the form of a percentage.

Furthermore, in the VAL 3 language, commands called “Open( )” and “Close( )” that take variables of the Tools type as parameters make it possible to steer a tool defined in the “TOOLS” table 152, for example to open or close a gripper.

To achieve this functionality, the server program 30 of the computing unit 11 acquires the identifier of the approach movement ML6 and for example stores it in the “ApproID” variable. To that end, the sequences of instructions containing the elementary movement instructions iME may be modified as follows:

pointDepart= POINTS[n] [0]*depart
MOVE (pointDepart ,TOOLS[m], mdescDepart )
FOR index = 1 to NumberOfVariablesIn(POINTS[n])−1
MOVE (POINTS[n] [index], TOOLS[m], MDESCS[o])
END_FOR
pointAppro= POINTS[n] [NumberOfVariablesIn(POINTS[n])]*appro
MOVE (pointAppro,TOOLS[m], MDESCS[o])
ApproID=MOVE (POINTS[n] [NumberOfVariablesIn(POINTS[n])],
TOOLS[m], mdescAppro)

Furthermore, a parallel task is launched on the computing unit 11, which consists of observing the advancement of the movement whereof the identifier has been acquired, and triggering a predetermined action when the advancement of the movement reaches the value specified in the “ActionTrigger” parameter. The instructions of the parallel task to initiate the action can be written as follows, in the VAL 3 language:

```
Forever
    Wait GetMotionProgress(ApproID)==ActionTrigger
        If OpenOrClose ==TRUE
            Open(TOOLS[m],)
        else
            Close(TOOLS[m],)
    EndWait
EndForever
```

The method according to the invention is preferably, but not exclusively, implemented using Ethercat interfacing. It essentially requires a means of communication, which may be of a type other than the Ethercat fieldbus. For example, the method according to the invention may be implemented with a MODBUS bus.

In its preferred embodiment, the invention provides that the trajectory data are transmitted with reference to parameters stored in the memory of the robot controller 10 in the trajectory order Om. Alternatively, the trajectory data may also be transmitted by value, i.e., by defining, in the movement instructions created by the programmer of the PLC 6, point coordinates, speeds, or other parameters. For example, the two points of a trajectory may be entered directly by their coordinates in a MOVE instruction. In particular, the data corresponding to the early initiation of the tool command may advantageously be transmitted by value, since their development is done based on the execution of the application 20 in the PLC 6.

Likewise, the invention is based on a transmission of trajectory orders according to a protocol based on tables of inputs/outputs. It may be implemented by using a transmission based on a client/server architecture establishing the sending and receiving of messages containing the trajectory orders.

The features of the embodiments and alternatives described above may be combined to form new embodiments of the invention.

1. A method for controlling an automated work cell, including:
at least one robot arm with at least three degrees of freedom,
a programmable logic controller suitable for developing a trajectory order based on an instruction to perform a trajectory of an application programmed in the programmable logic controller,
a robot controller, suitable for steering the movement of the robot arm, and
a communication bus between the programmable logic controller and the robot controller,
wherein the method comprises the following steps:
a) developing, in the programmable logic controller, a trajectory order including parameters for performing a trajectory defined at least between a departure point and an arrival point;
b) sending the trajectory order developed in step a) to a computing unit of the robot controller;
c) developing, in the computing unit of the robot controller and based on the trajectory order transmitted in step b), elementary movement instructions for steering the robot arm on the trajectory defined by the trajectory order.

2. The control method according to claim 1, wherein in the trajectory order developed in step a), the trajectory is defined by a reference to a set of predefined points stored in a memory of the robot controller, this reference being entered in a variable contained in the trajectory order.

3. The control method according to claim 1, wherein in the trajectory order developed in step a), kinematic parameters to be used to execute the trajectory are defined.

4. The control method according to claim 3, wherein the kinematic parameters to be used to execute the trajectory are defined by a reference to kinematic parameters stored in a memory of the robot controller and entered in a variable contained in the trajectory order.

5. The control method according to claim 1, wherein in the trajectory order developed in step a), starting parameters for the first point of the trajectory and/or the approach to the last point of the trajectory, which are implemented by the robot controller in the execution of the trajectory, are defined.

6. The control method according to claim 5, wherein the departure kinematic parameters for the first point of the trajectory and/or the approach to the last point of the trajectory are defined by a reference to starting and approach parameters stored in a memory of the robot controller and entered in variables contained in the trajectory order.

7. The control method according to claim 1, wherein the trajectory order developed in step a) comprises actions to be performed by a tool equipping one end of the robot arm.

8. The control method according to claim 1, wherein in the trajectory order developed in step a), the geometry of the tool to be used is defined.

9. The control method according to claim 8, wherein the geometry of the tool to be used is defined by a reference to a predefined tool geometry stored in a memory of the robot controller, this reference being entered in a variable contained in the trajectory order.

10. The control method according to claim 1, wherein the trajectory order developed in step a) comprises actions to be performed by a tool equipping one end of the robot arm, and wherein the initiation of an action of the tool by the robot controller and conditions for initiation of this action are entered in a variable contained in the trajectory order.

11. The control method according to claim 10, wherein the conditions for triggering the action of the tool consist of observing the state of advancement of a movement of the robot arm and triggering the action of the tool when the state of advancement of the movement reaches a predefined value.

12. The control method according to claim 1, wherein in step a), the programmable logic controller updates inputs/outputs of this programmable logic controller based on execution parameters of the trajectory according to a defined exchange protocol, and in step b), the computing unit of the robot controller reads the inputs/outputs of the computing unit that correspond to the inputs/outputs of the programmable logic controller as part of this exchange protocol.
